(19) United States
(12) Patent Application Publication
(10) Pub. No.: US 2026/0276157 A1
(43) Pub. Date: Sep. 17, 2026

(54) FLARE GAS CAPTURE APPARATUS, CONTROL, AND ASSOCIATED METHODS

(71) Applicant: TPE Midstream LLC, Tulsa, OK (US)

(72) Inventor: Douglas A. Sahm, Lutz, FL (US)

(21) Appl. No.: 19/471,567

(22) PCT Filed: Apr. 5, 2024
(86) PCT No.: PCT/US2024/023358

§ 371 Date: Oct. 1, 2025

Related U.S. Application Data
(60) Provisional application No. 63/495,706, filed on Apr. 12, 2023.

(51) Int. Cl. F17D 1/02; F23G 7/08

(52) U.S. Cl. CPC F17D 1/02; F23G 7/08; F23G 2207/102; F23G 2207/20; F23G 2209/14

(57) ABSTRACT

Example flare gas capture apparatus, control, and associated methods are disclosed herein. An example apparatus includes a fluid evacuation system operatively coupled to a gas flare line to evacuate gas from the gas flare line, and a valve operatively coupled to the gas flare line downstream of the fluid evacuation system and upstream of a vent of the gas flare line, the valve movable between a first position and a second position based on a pressure of the gas, the valve to restrict flow of the gas to the vent in the first position, the valve to enable the flow of the gas to the vent in the second position.

### RELATED APPLICATION

This patent claims priority to U.S. Provisional Application No. 63/495,706, titled “Flare Gas Capture Apparatus, Control, and Associated Methods,” filed Apr. 12, 2023. U.S. Provisional Application No. 63/495,706 is hereby incorporated by reference in its entirety.

### FIELD OF THE DISCLOSURE

This disclosure relates generally to gas pipelines and, more particularly, to flare gas capture apparatus, control, and associated methods.

### BACKGROUND

Natural gas is a common byproduct of oil extraction and/or processing. In some oil production facilities, gas is evacuated from a first location and released to the atmosphere at a second location. Natural gas includes methane and/or one or more other constituent gases which, when vented to the atmosphere, can be wasteful and harmful to the environment. In some instances, flaring (e.g., burning) the gas can be performed to reduce an amount of the gas released to the atmosphere.

### BRIEF DESCRIPTION OF THE DRAWINGS

FIG. 1 illustrates a known gas flaring setup implemented on an example flare line.

FIG. 2A illustrates an example flare gas capture system in accordance with teachings of this disclosure.

FIG. 2B illustrates a second example flare gas capture system including an example non-pressurized separator.

FIG. 3A is a schematic illustration of an example fluid evacuation system of FIGS. 2A and/or 2B.

FIG. 3B illustrates example compressor units of FIG. 3A configured for electrical actuation.

FIG. 3C illustrates a perspective view of an example linear actuator of FIG. 3B.

FIG. 4 is a flowchart representative of example instructions which may be executed to implement a flare gas capture procedure as described in connection with FIGS. 2A and/or 2B.

FIG. 5 is a flowchart representative of example machine readable instructions and/or example operations that may be executed by example programmable circuitry to implement an example control system of FIGS. 2A and/or 2B.

FIG. 6 is a block diagram of an example processing platform including programmable circuitry structured to execute, instantiate, and/or perform the example machine readable instructions and/or perform the example operations of FIG. 5 to implement the control system of FIGS. 2A and/or 2B.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

Buildings, plants, factories, and other facilities commonly use natural gas for various purposes such as heating, power generation, transportation, etc. In some instances, natural gas is a byproduct of an oil production process. In some oil production facilities, fluid from a first location (e.g., an oil well) is separated into oil and gas using a separator, and the gas is typically redirected to a second location (e.g., a vent, a flare line, etc.) for venting and/or flaring. Natural gas is composed of methane and/or one or more other constituent gases (e.g., carbon dioxide, water vapor, ethane, propane, etc.) that, when vented to the atmosphere, can be harmful to the environment and may pose a safety concern due to a risk of accidental combustion. As such, gas may be flared (e.g., burned, combusted) to reduce an amount of the gas released to the atmosphere and/or reduce the risk of accidental combustion. During a flaring procedure, the gas vented from a pipe is intentionally ignited, and methane from the gas is converted to other gases (e.g., carbon dioxide) as a result of combustion of the methane. Such resultant gases may be less environmentally harmful compared to methane, but can likewise produce some harmful environmental effects. Further, combustion efficiency of a flaring procedure is typically less than 100%, such that at least some of the methane is not burned off and is released to the atmosphere. Additionally, venting and/or flaring of gas can be economically wasteful, since the gas may be useful for other purposes such as heating and/or power generation.

Examples disclosed herein reduce emissions of harmful gases to the atmosphere by compressing and/or storing gas instead of flaring. In examples disclosed herein, an example fluid transfer system (e.g., a fluid compression system) is implemented on an example gas flare line. In some examples, the gas flare line fluidly couples a first location, such as a separator (e.g., a gas and oil separator, a pressurized separator, a non-pressurized separator), to a vent (e.g., a flare vent). The example fluid transfer system evacuates and/or compresses the gas from the gas flare line, and provides the compressed gas to a second location for storage and/or redistribution of the gas. In some examples, a valve (e.g., a back pressure control valve (BPCV)) is implemented along the gas flare line between the fluid transfer system and the vent. In some examples, when a pressure of the gas in the gas flare line satisfies (e.g., is less than or equal to) a threshold pressure, the valve is closed to prevent flow of gas to the vent while the fluid transfer system is pumping the gas from the gas flare line. Conversely, when the pressure of the gas in the gas flare line does not satisfy (e.g., is greater than) the threshold pressure, the valve opens to allow the gas to flow to the vent, thus reducing likelihood of damage resulting from excessive pressure in the gas flare line. Advantageously, examples disclosed herein reduce an amount of methane and/or other gases released to the environment, thus reducing harm to the environment and/or economic waste.

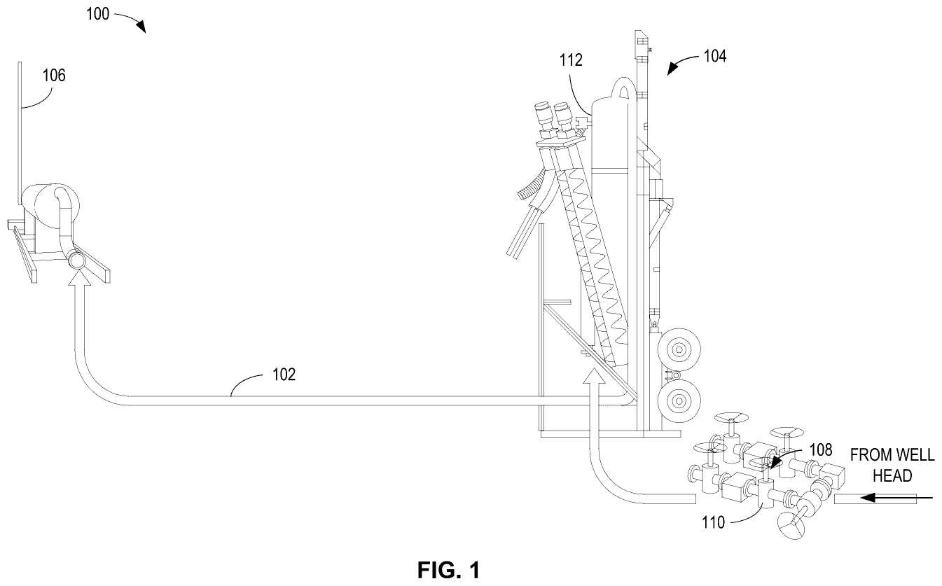

FIG. 1 is a block diagram of a known gas flaring setup 100 implemented on a flare line (e.g., a gas flare line) 102. In FIG. 1, the flare line 102 fluidly couples a separator (e.g., an oil and gas separator, a pressurized separator) 104 to a vent 106. The separator 104 is further fluidly coupled to a choke manifold 108. In FIG. 1, the choke manifold 108 is to receive fluid (e.g., an oil and gas mixture) from a well head of an oil production facility. The choke manifold 108 includes a plurality of choke valves 110 that can be adjusted to control flow and/or pressure of the fluid flowing therethrough. In particular, the choke manifold 108 reduces the flow and/or pressure of the fluid from the choke manifold 108 to the separator 104, thus reducing likelihood of damage to the separator 104 resulting from exposure of the separator 104 to high pressures (e.g., pressures greater than a threshold pressure).

In FIG. 1, the separator 104 separates the fluid from the choke manifold 108 into constituent fluids (e.g., oil, gas, and/or other constituent fluids such as water). For instance, the constituent fluids can be separated into different locations of a vessel (e.g., a pressure vessel) 112 of the separator 104 by gravity causing the gas to rise toward a top of the vessel 112 and causing the oil to settle below the gas in the vessel 112. In some instances, the oil is diverted to other locations for subsequent processing and/or distribution, and the gas is diverted to the vent 106 via the flare line 102. The gas is ignited at the vent 106, and combustion of the gas results in release of constituent gases (e.g., carbon monoxide and/or other constituent gases) into the atmosphere. The release of such gases into the atmosphere may be harmful to the environment and/or economically wasteful.

While the gas flaring setup 100 of FIG. 1 is used in connection with the separator 104 of an oil production facility, the gas flaring setup 100 can be used to remove and/or flare gas from one or more different devices and/or environments. For example, the gas flaring setup 100 can be used in connection with a gas plant facility, a compressor station, etc.

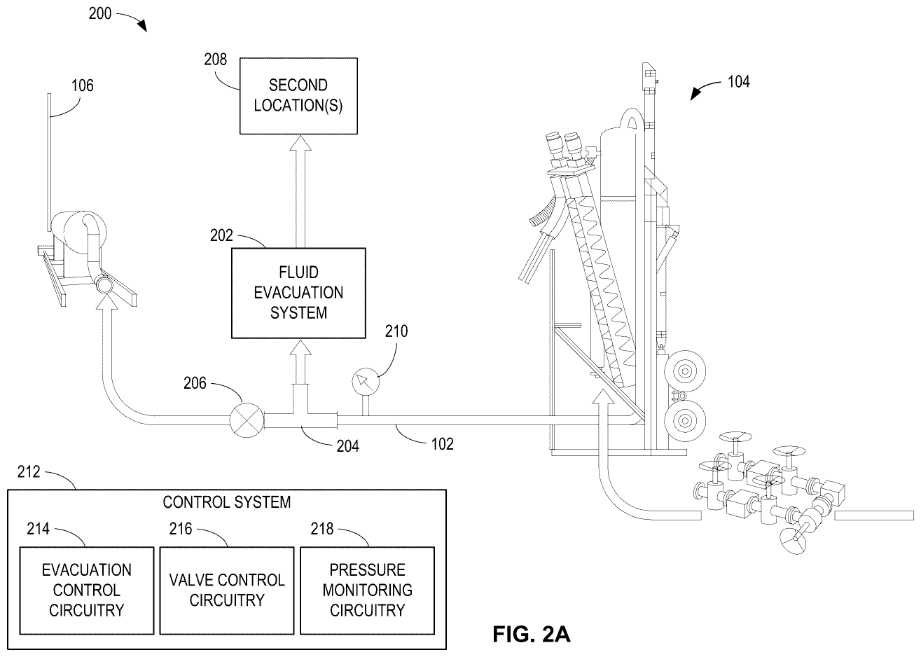

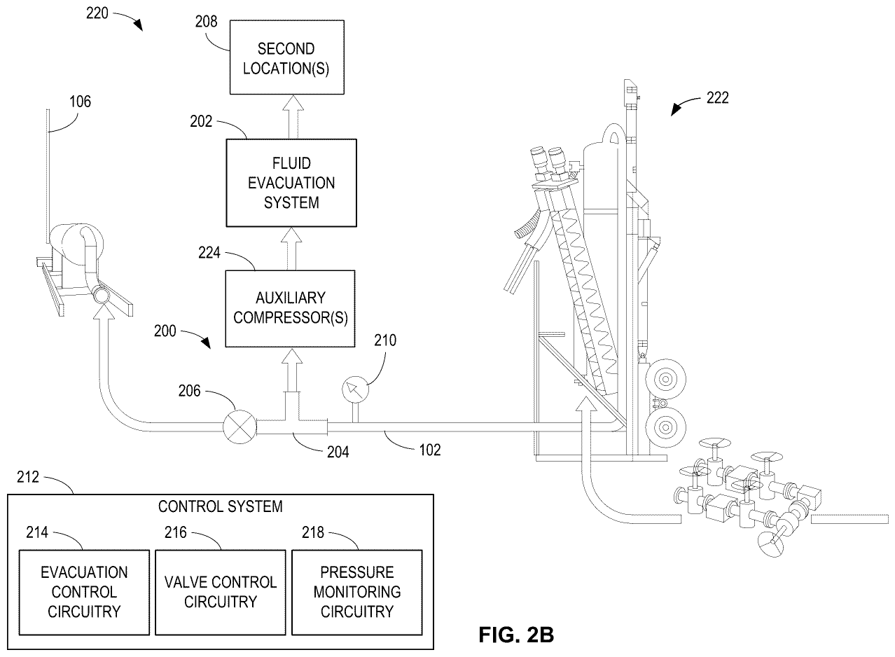

FIG. 2A illustrates a first example flare gas capture system 200 constructed in accordance with teachings of this disclosure. In the illustrated example of FIG. 2A, the first flare gas capture system 200 is implemented on the flare line 102 of FIG. 1 to divert gas from the flare line 102 and compress the diverted gas for transportation and/or storage. In FIG. 2A, the first flare gas capture system 200 includes an example fluid evacuation system 202 fluidly and/or operatively coupled to the flare line 102 via an example tee 204, and an example valve (e.g., a back pressure control valve (BPCV)) 206 fluidly and/or operatively coupled to the flare line 102 downstream of the tee 204.

In the illustrated example of FIG. 2A, the separator 104 is a pressurized separator in which the separation of oil and gas occurs in a pressurized environment (e.g., a pressure vessel). In some examples, when gas exits the separator 104 and flows toward the vent 106 via the flare line 102, the fluid evacuation system 202 is turned on and begins to pump the gas from the flare line 102. In some examples, the fluid evacuation system 202 compresses the gas, and then pumps the compressed gas to one or more second example locations 208. In some examples, the second location(s) 208 correspond to a different gas pipeline and/or an example gas storage (e.g., a storage unit) for storing the compressed gas. In some such examples, the compressed gas in the gas storage can be temporarily stored and later pumped into a gas pipeline. In some examples, the second location(s) 208 correspond to a downhole location of a well (e.g., a decommissioned oil and/or gas well). In some examples, when the second location(s) 208 correspond to a gas pipeline and/or a gas storage, the fluid evacuation system 202 compresses the gas to a first example pressure (e.g., 150 pounds-per-square-inch-gauge (psig), 200 psig, etc.) prior to providing the compressed gas to the second location(s) 208. In some examples, when the second location(s) 208 correspond to a downhole location of a well, the fluid evacuation system 202 compresses the gas to a second example pressure (e.g., 1000 psig, 2000 psig, 2500 psig, etc.) prior to providing the compressed gas to the second location(s) 208. In the illustrated example of FIG. 2A, as a result of the evacuation of the gas from the flare line 102, the gas is restricted and/or prevented from flowing to the vent 106, which reduces an amount of gas to be flared and/or released to the atmosphere.

In some examples, the valve 206 is closed during operation of the fluid evacuation system 202 to prevent and/or restrict flow of gas to the vent 106. In some examples, the valve 206 is manually closed by an operator. In some examples, the valve 206 is automatically closed when a pressure of the gas in the flare line 102 does not satisfy (e.g., is less than) a threshold pressure. In some examples, the pressure in the gas may rise to or above the threshold pressure, such as when flow rate of gas into the fluid evacuation system 202 is less than a flow rate of gas entering the flare line 102. In such examples, to prevent and/or reduce damage to the fluid evacuation system 202 and/or the separator 104 resulting from excess pressures in the flare line 102, the valve 206 opens to relieve pressure in the flare line 102 and allow at least some of the gas in the flare line 102 to be vented and/or flared from the vent 106.

In some examples, the valve 206 moves to an open position automatically when the pressure in the flare line 102 satisfies (e.g., is at or above) the threshold pressure. For example, the pressure can cause the valve 206 to move to the open position. In some examples, an operator manually moves the valve 206 to the open position. In the example of FIG. 2A, an example pressure sensor 210 is operatively coupled to the flare line 102 upstream of the valve 206 to measure and/or display the pressure of the gas in the flare line 102. In some examples, the pressure sensor 210 is communicatively and/or operatively coupled to the valve 206, and the pressure sensor 210 provides a signal (e.g., a pneumatic signal and/or an electrical signal) to the valve 206 to control a position thereof. For example, when the pressure sensor 210 detects that the pressure is below the threshold pressure and the valve 206 is in the open position, the pressure sensor 210 sends the signal to the valve 206 to cause the valve 206 to move to the closed position. Conversely, when the pressure sensor 210 detects that the pressure is at or above the threshold pressure and the valve 206 is in the closed position, the pressure sensor 210 sends the signal to the valve 206 to cause the valve 206 to move to the open position.

In the illustrated example of FIG. 2A, the fluid evacuation system 202 is configured to continuously pump gas from the flare line 102 to the second location 208 while the separator 104 is operating. In some examples (e.g., when the oil and gas separation process is complete and/or the separator 104 is no longer operating), an operator can manually turn on or shut off the fluid evacuation system 202 (e.g., by using a switch, by opening or closing a control valve, etc.). In some such examples, the operator reads a pressure displayed by the pressure sensor 210 and, based on the pressure, the operator determines whether to turn on or shut off the fluid evacuation system 202. In some examples, the pressure sensor 210, the fluid evacuation system 202, and/or the valve 206 can be communicatively and/or operatively coupled to an example control system 212 and/or another controller, processor, etc., and controllable via command signals sent from the control system 212, the controller, and/or the processor, etc. For example, in the illustrated example of FIG. 2A, the example control system 212 includes example evacuation control circuitry 214 communicatively and/or operatively coupled to the fluid evacuation system 202, example valve control circuitry 216 communicatively and/or operatively coupled to the valve 206, and example pressure monitoring circuitry 218 communicatively and/or operatively coupled to the pressure sensor 210.

In the illustrated example of FIG. 2A, the pressure monitoring circuitry 218 monitors and/or detects a pressure of the gas in the flare line 102 based on measurement data from the pressure sensor 210. In some examples, the pressure monitoring circuitry 218 compares the pressure to one or more pressure thresholds. For example, in response to the pressure monitoring circuitry 218 determining that the measured pressure is above a first pressure threshold (e.g., 0 psig, 0.1 psig, 0.2 psig, etc.), the pressure monitoring circuitry 218 detects presence of gas in the flare line 102, and the evacuation control circuitry 214 turns on the fluid evacuation system 202 to pump the gas from the flare line 102. Conversely, in response to the pressure monitoring circuitry 218 determining that the measured pressure is below the first pressure threshold, the pressure monitoring circuitry 218 determines that there is little or no gas in the flare line 102, and the evacuation control circuitry 214 shuts off the fluid evacuation system 202. In some examples, in response to the pressure monitoring circuitry 218 determining that the measured pressure is below a second threshold pressure (e.g., greater than the first threshold pressure, 1 psig, 2 psig, etc.), the valve control circuitry 216 causes the valve 206 to move (e.g., via a control signal, a pneumatic signal, etc.) to the closed position to prevent and/or restrict flow of gas to the vent 106. Conversely, in response to the pressure monitoring circuitry 218 determining that the measured pressure is at or above the second threshold pressure, the valve control circuitry 216 causes the valve 206 to move to the open position to enable flow of gas to the vent 106.

FIG. 2B illustrates a second example flare gas capture system 220 operatively coupled to an example non-pressurized separator (e.g., an atmospheric separator) 222. In the illustrated example of FIG. 2B, the second flare gas capture system 220 includes the tee 204, the valve 206, and the fluid evacuation system 202 of FIG. 2A implemented along the flare line 102, and further includes one or more example auxiliary compressors 224 fluidly and/or operatively coupled between the tee 204 and the fluid evacuation system 202. In this example, the flare line 102 fluidly couples the non-pressurized separator 222 to the vent 106.

In contrast to the separator 104 of FIGS. 1 and/or 2A, the non-pressurized separator 222 of FIG. 2B operates at or near atmospheric pressure (e.g., 0 psig). In some examples, exposure of one or more components of the non-pressurized separator 222 to excessive pressure (e.g., 1 psig or greater, 1.5 psig or greater, etc.) may result in damage to and/or malfunction of the non-pressurized separator 222. As such, the second flare gas capture system 220 operates to maintain a pressure in the flare line 102 that is less than a threshold pressure (e.g., 1 psig, 0.5 psig, etc.) to reduce risk of exposure of the non-pressurized separator 222 to excessive pressure.

For example, the valve 206 of FIG. 2B may be set to open when the pressure in the flare line 102 (e.g., upstream of the valve 206) is at or above the threshold pressure to enable venting of gas from the non-pressurized separator 222 via the vent 106. In some examples, to reduce an amount of gas vented to atmosphere while maintaining sufficiently low pressure (e.g., less than the threshold pressure, less than 1 psig, less than 2 psig) in the flare line 102, the auxiliary compressor(s) 224 of FIG. 2B draw gas from the flare line 102 and/or provide the gas to the fluid evacuation system 202. For example, the auxiliary compressor(s) 224 compress the gas from the flare line 102 to increase a pressure of the gas from a first example pressure (e.g., 0 psig, less than 1 psig, etc.) to a second example pressure (e.g., 45 psig or greater, 150 psig or less, etc.). In some such examples, the auxiliary compressor(s) 224 provide the compressed to the fluid evacuation system 202 at the second pressure, where the fluid evacuation system 202 can further compress the gas to a third example pressure (e.g., 150 psig or greater, 500 psig or greater, 1000 psig or greater, etc.) prior to providing the compressed gas to the second location(s) 208.

In some examples, the auxiliary compressor(s) 224 include one or more screw compressors (e.g., rotary-screw compressors), one or more reciprocating compressors, one or more axial compressors, one or more centrifugal compressors, and/or one or more different types of compressors. In some examples, ones of the auxiliary compressor(s) 224 can be arranged in a series configuration and/or in a parallel configuration to adjust a pressure increase across the auxiliary compressor(s) 224. In some examples, the auxiliary compressor(s) 224 can include second one(s) of the fluid evacuation system 202 of FIG. 2B.

In some examples, the evacuation control circuitry 214 of the control system 212 is communicatively and/or operatively coupled to the fluid evacuation system 202 and the auxiliary compressor(s) 224. In some such examples, in response to the pressure monitoring circuitry 218 determining that the pressure of gas in the flare line 102 is above a first pressure threshold (e.g., 0 psig, 0.1 psig, 0.2 psig, etc.), the pressure monitoring circuitry 218 detects presence of gas in the flare line 102, and the evacuation control circuitry 214 turns on (e.g., activates) the auxiliary compressor(s) 224 and/or the fluid evacuation system 202 to pump the gas from the flare line 102. Conversely, in response to the pressure monitoring circuitry 218 determining that the measured pressure is below the first pressure threshold, the pressure monitoring circuitry 218 determines that there is little or no gas in the flare line 102, and the evacuation control circuitry 214 shuts off the auxiliary compressor(s) 224 and/or the fluid evacuation system 202.

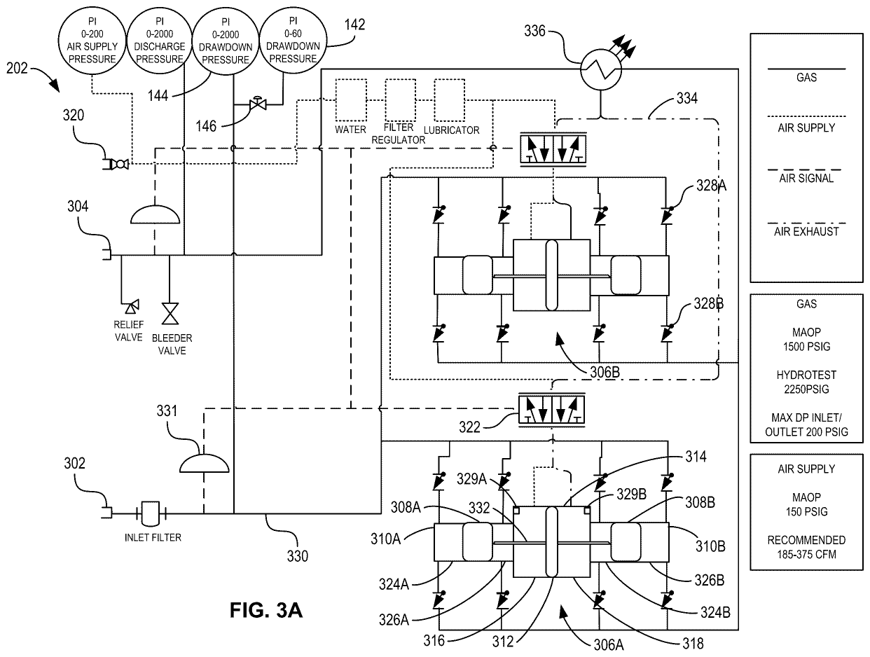

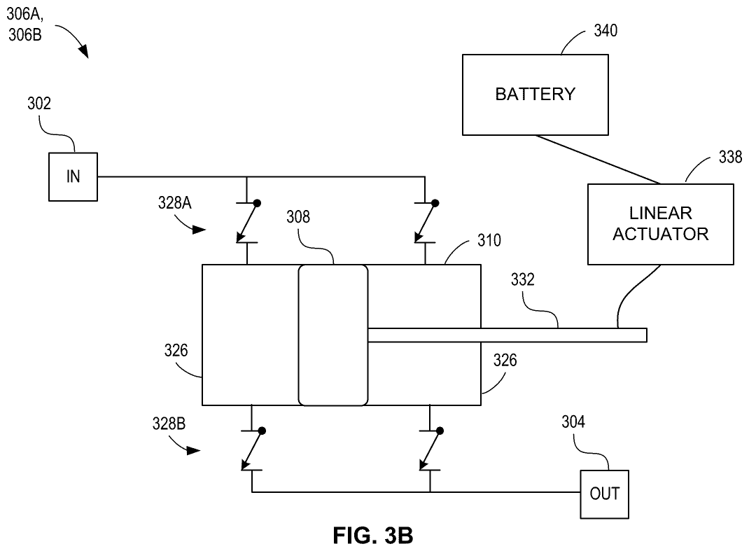

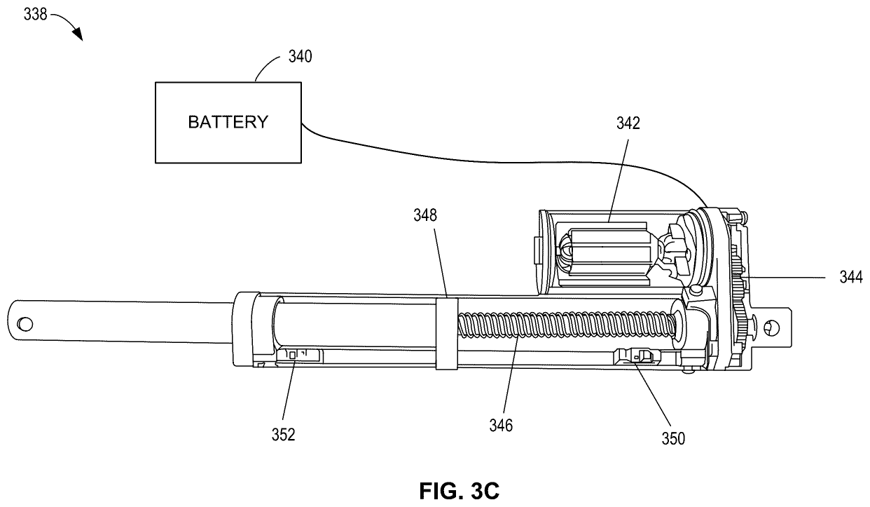

FIG. 3A is a schematic illustration of the example fluid evacuation system 202 of FIGS. 2A and/or 2B. The example fluid evacuation system 202 is configured to transport fluid (e.g., gas) from a first location (e.g., the flare line 102 of FIGS. 1, 2A, and/or 2B) to the second location 208 of FIGS. 2A and/or 2B. The example fluid evacuation system 202 includes an example fluid intake 302 couplable to the flare line 102 and an example fluid discharge 304 couplable to the second location 208. Fluid is compressed by example compressor units 306A, 306B as the fluid flows from the fluid intake 302 to the fluid discharge 304. The compressor units 306A, 306B each include example compression pistons 308A, 308B implemented in example compression cylinders 310A, 310B, and an example air piston 312 implemented in an example air cylinder 314. The air cylinder 314 includes an example first chamber 316 and an example second chamber 318 coupled to an example air supply 320 via an example air control valve 322. The compression cylinders 310A, 310B include example third chambers 324A, 324B and example fourth chambers 326A, 326B coupled to the fluid intake 302 via inlet check valves 328A, and coupled to the fluid outlet via outlet check valves 328B.

In the illustrated example of FIG. 3A, fluid enters via the fluid intake 302 and flows to the compressor units 306A, 306B via example piping 330. The fluid enters the third chambers 324A, 324B and the fourth chambers 326A, 326B through the inlet check valves 328A. The inlet check valves 328A allow the fluid to flow unidirectionally from the fluid intake 302 to the compressor units 306A, 306B. The air control valve 322 also directs compressed air from the air supply 320 to enter the air cylinder 314. The air control valve 322 can alternate flow of the compressed air between the first chamber 316 and the second chamber 318. In the illustrated example of FIG. 3A, the air control valve 322 directs compressed air into the first chamber 316 in response to a first switch 329A being engaged, and directs compressed air into the second chamber 318 in response to a second switch 329B being engaged, where the first switch 329A and the second switch 329B are operatively coupled to the air control valve 322. In other examples, the air control valve 322 can switch a direction of flow of the compressed air based on a command and/or a signal from a computer and/or other processor communicatively coupled to the air control valve 322.

In the illustrated example of FIG. 3A, an under-pressure cutoff 331 is coupled to the piping 330 between the fluid intake 302 and the air control valve 322. In some examples, the under-pressure cutoff 331 can detect whether a pressure of the fluid in the piping 330 drops below a threshold pressure (e.g., cutoff pressure). In response to the under-pressure cutoff 331 determining that the pressure of the fluid has dropped below the cutoff pressure, the under-pressure cutoff 331 can send an air signal to the air control valve 322 to shut off the flow of compressed air into the compressor units 306A, 306B and, as such, prevent the compressor units 306A, 306B from further compressing the fluid.

In the illustrated example of FIG. 3A, in response to the air control valve 322 directing the compressed air to flow into the first chamber 316, the compressed air generates pressure on the air piston 312 to move the air piston 312 to the right (e.g., towards the second compression cylinder 310B). The air piston 312 is operatively coupled to the compression pistons 308A, 308B via an example rod 332, such that the compression pistons 308A, 308B move with the air piston 312. In response to the air piston 312 moving to the right and, thus, the compression pistons 308A, 308B moving to the right, the fluid in the fourth chambers 326A, 326B is compressed by the compression pistons 308A, 308B. Compressed fluid is expelled from the fourth chambers 326A, 326B and flows through the respective outlet check valves 328B towards the fluid discharge 304. The outlet check valves 328B allow the fluid to flow unidirectionally from the fluid intake 302 to the compressor units 306A, 306B.

In response to the air piston 312 being positioned to the right (in reference to the arrangement of FIG. 3A), the air piston 312 engages the second switch 329B coupled to the right side of the air cylinder 314. In response to the second switch 329B being engaged, the air control valve 322 stops the flow of compressed air to the first chamber 316 and directs the flow of compressed air to enter the second chamber 318. The compressed air from the first chamber 316 can be expelled to the atmosphere via air exhaust tubing 334. In some examples, the compressed air from the first chamber 316 can be used to cool the compressed fluid via an example heat exchanger 336 prior to the compressed air being expelled to the atmosphere.

In response to the air control valve 322 directing the flow of compressed air to enter the second chamber 318, the compressed air causes the air piston 312 and the compression pistons 308A, 308B to move to the left (e.g., toward the first compression cylinder 310A). The fluid in the third chambers 324A, 324B is compressed by the compression pistons 308A, 308B. The compressed fluid is expelled from the third chambers 324A, 324B and flows through the respective outlet check valves 328B towards the fluid discharge 304.

In response to the air piston 312 being positioned to the left (in reference to the arrangement of FIG. 3A), the air piston 312 engages the first switch 329A coupled to the left side of the air cylinder 314. In response to the first switch 329A being engaged, the air control valve 322 stops the flow of compressed air to the second chamber 318 and once again directs the flow of compressed air to enter the first chamber 316. In the illustrated example of FIG. 3A, the air control valve 322 continuously redirects the flow of compressed air between the first chamber 316 and the second chamber 318 to compress fluid entering the third chambers 324A, 324B and the fourth chambers 326A, 326B.

In the illustrated example of FIG. 3A, the fluid evacuation system 202 includes two compressor units (e.g., the first compressor unit 306A and the second compressor unit 306B). In other examples, to reduce a size of the fluid evacuation system 202, only one of the compressor units (e.g., the first compressor unit 306A or the second compressor unit 306B) is used. In other examples, multiple ones (e.g., three or more) of the compressor units are used. In such examples, the rate of compression and/or the differential pressure of the gas compressed by the fluid evacuation system 202 can be modified by selectively configuring an arrangement of the compressor units (e.g., in a series arrangement and/or in a parallel arrangement).

FIG. 3B illustrates the compressor units 306A, 306B of FIG. 3A configured for electrical, rather than pneumatic, actuation. In such examples, gas from the fluid intake 302 of FIG. 3A is not compressed using compressed air from the air supply 320, but rather is compressed via an example linear actuator 338. As such, in this example, the fluid evacuation system 202 does not include the air control valve 322, the air supply 320, and/or the air exhaust tubing 334 of FIG. 3A. The linear actuator 338 is coupled to and/or powered by an example battery 340.

In the illustrated example of FIG. 3B, the linear actuator 338 is operatively coupled to the rod 332 to move the gas piston 308 (e.g., the first gas piston 308A or the second gas piston 308B of FIG. 3A) inside the compression cylinder 310 (e.g., the first compression cylinder 310A or the second compression cylinder 310B of FIG. 3A). In this example, the linear actuator 338 is configured such that the gas piston 308 moves to the left when the linear actuator 338 extends, and the gas piston 308 moves to the right when the linear actuator 338 contracts. Alternatively, in other examples, the linear actuator 338 is configured such that the gas piston 308 moves to the left when the linear actuator 338 contracts, and the gas piston 308 moves to the right when the linear actuator 338 extends.

In this example, each of the compressor units 306A, 306B includes a single one of the gas pistons 308A, 308B and a corresponding one of the compression cylinders 310A, 310B. In such examples, each of the compressor units 306A, 306B includes corresponding ones of the linear actuator 338. In other examples, the linear actuator 338 can be coupled to both of the compressor units 306A, 306B to operate the compressor units 306A, 306B simultaneously. In other examples, the compressor units 306A, 306B can include both of the gas pistons 308A, 308B operated by the linear actuator 338.

In the illustrated example of FIG. 3B, in response to the linear actuator 338 moving the gas piston 308 to the right, the gas in the fourth chamber 326 is compressed by the gas piston 308. Compressed gas is expelled from the fourth chamber 326 and flows through the respective outlet check valves 328B towards the fluid discharge 304. Alternatively, in response to the linear actuator 338 moving the gas piston 308 to the left, the gas in the third chamber 324 is compressed by the gas piston 308. Compressed gas is expelled from the fourth chamber 326 and flows through the respective outlet check valves 328B towards the fluid discharge 304. In this example, the linear actuator 338 continuously moves between an extended position and a contracted position to compress gas entering the third chamber 324 and the fourth chamber 326 until the gas is evacuated from the first location (e.g., coupled to the fluid intake 302) and transferred to the second location (e.g., coupled to the fluid discharge 304).

FIG. 3C illustrates a perspective view of the example linear actuator 338 of FIG. 3B. The example linear actuator 338 includes an example motor 342 coupled to the battery 340 of FIG. 3B, an example gear box 344, an example lead screw 346, an example drill nut 348, an example retract limit switch 350, and an example extend limit switch 352. In the illustrated example of FIG. 3C, rotation of the motor 342 causes corresponding rotation of the lead screw 346 via the gear box 344. The rotation of the lead screw 346 causes linear travel of the drill nut 348 along the lead screw 346 and, as such, causes the linear actuator 338 to extend or retract based on a direction of rotation of the motor 342 and/or the lead screw 346. For example, the linear actuator 338 extends in response to the motor 342 rotating in a first direction, and the linear actuator 338 retracts in response to the motor 342 rotating in a second direction, where the second direction is opposite from the first direction.

In the illustrated example of FIG. 3C, in response to the linear actuator 338 being fully extended, the drill nut 348 engages the extend limit switch 352. In such examples, the extend limit switch 352 sends a first electrical signal to the motor 342. In some examples, the first electrical signal causes the motor 342 to stop rotating and/or reverse the direction of rotation (e.g., from the first direction to the second direction). Alternatively, in response to the linear actuator 338 being fully retracted, the drill nut 348 engages the retract limit switch 350. In such examples, the retract limit switch 350 sends a second electrical signal to the motor 342. In some examples, where the first electrical signal causes the motor 342 to stop rotating and/or reverse the direction of rotation (e.g., from the second direction to the first direction). As such, repeatedly engaging the retract limit switch 350 and the extend limit switch 352 causes linear reciprocal travel of the linear actuator 338 to compress the gas in the compression cylinder 310 of FIG. 3B.

While an example manner of implementing the control system 212 of FIGS. 2A and/or 2B is illustrated in FIGS. 2A and/or 2B, one or more of the elements, processes, and/or devices illustrated in FIGS. 2A and/or 2B may be combined, divided, re-arranged, omitted, eliminated, and/or implemented in any other way. Further, the example evacuation control circuitry 214, the example valve control circuitry 216, the example pressure monitoring circuitry 218, and/or, more generally, the example control system 212 of FIGS. 2A and/or 2B, may be implemented by hardware alone or by hardware in combination with software and/or firmware. Thus, for example, any of the example evacuation control circuitry 214, the example valve control circuitry 216, the example pressure monitoring circuitry 218, and/or, more generally, the example control system 212, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example control system 212 of FIGS. 2A and/or 2B may include one or more elements, processes, and/or devices in addition to, or instead of, those illustrated in FIGS. 2A and/or 2B, and/or may include more than one of any or all of the illustrated elements, processes and devices.

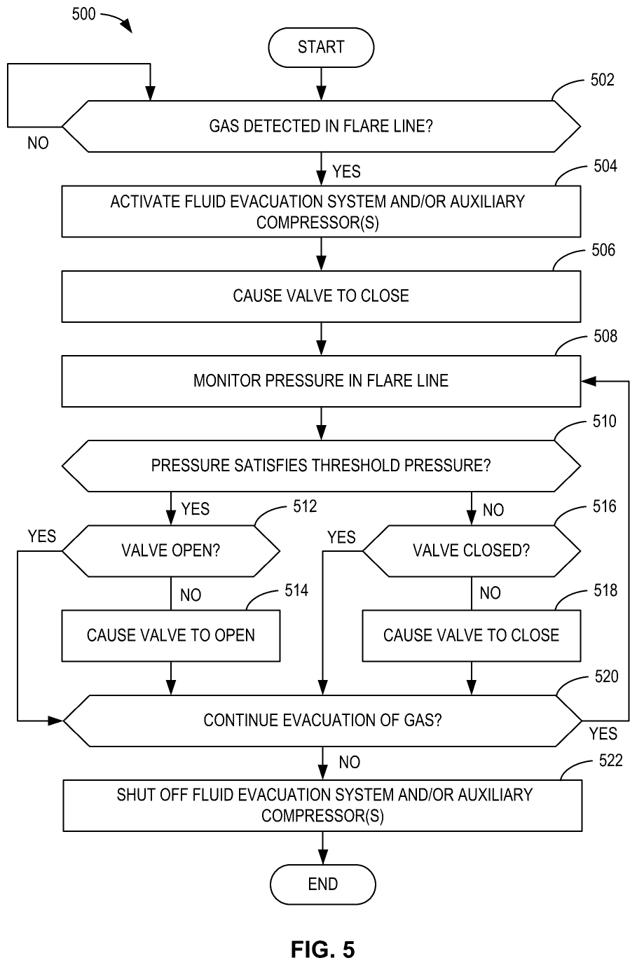

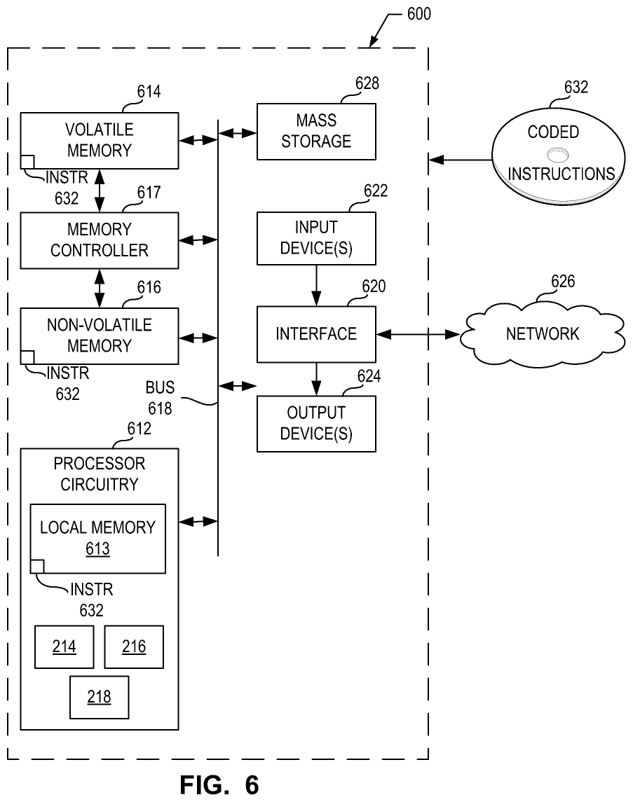

A flowchart representative of example machine readable instructions, which may be executed by programmable circuitry to implement and/or instantiate the control system 212 of FIGS. 2A and/or 2B and/or representative of example operations which may be performed by programmable circuitry to implement and/or instantiate the control system 212 of FIGS. 2A and/or 2B, is shown in FIG. 5. The machine readable instructions may be one or more executable programs or portion(s) of one or more executable programs for execution by programmable circuitry such as the processor circuitry 612 shown in the example processor platform 600 discussed below in connection with FIG. 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example control system 212 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

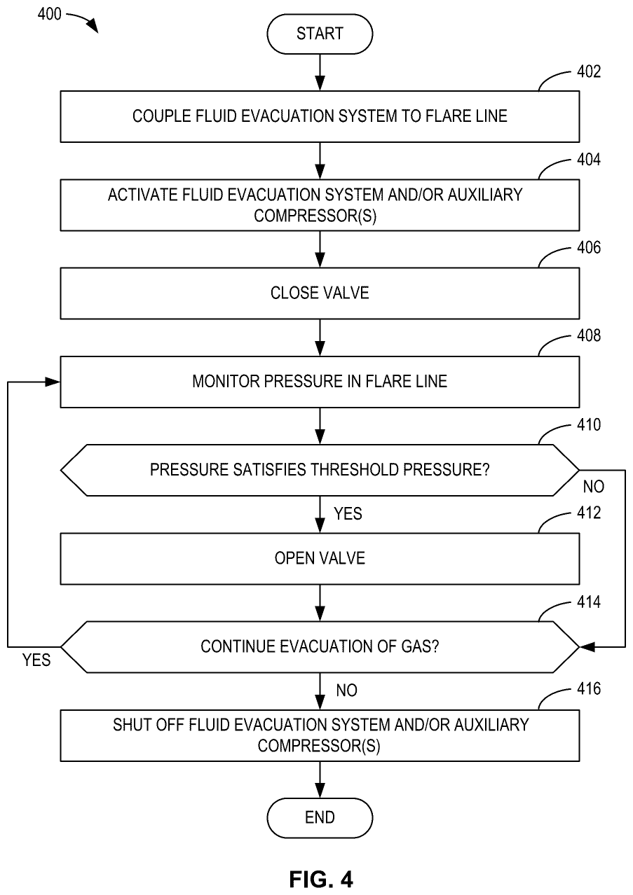

FIG. 4 is a flowchart representative of example operations 400 to implement a flare gas capture procedure as described in connection with FIGS. 2A and/or 2B. The operations 400 begin as gas from the separator 104 of FIGS. 1 and/or 2A and/or from the non-pressurized separator 222 of FIG. 2B is introduced to the flare line 102 of FIGS. 1, 2A, and/or 2B.

At block 402, the example fluid evacuation system 202 of FIGS. 2A and/or 2B is coupled to the flare line 102. For example, an operator fluidly and/or operatively couples the fluid evacuation system 202 to the flare line 102 at the example tee 204 of FIGS. 2A and/or 2B. In some examples, the fluid evacuation system 202 is further fluidly and/or operatively coupled to the example second location 208 of FIGS. 2A and/or 2B, where the second location 208 corresponds to a gas storage unit, a gas pipeline, and/or a downhole location of a well. In some examples, the auxiliary compressor(s) 224 of FIG. 2B are fluidly and/or operatively coupled between the tee 204 and the fluid evacuation system 202.

At block 404, the example fluid evacuation system 202 and/or the auxiliary compressor(s) 224 is/are activated. For example, the operator activates the fluid evacuation system 202 and/or the auxiliary compressor(s) 224 so that the fluid evacuation system 202 and/or the auxiliary compressor(s) 224 can begin compressing and/or evacuating gas from the flare line 102. In some examples, the fluid evacuation system 202 provides the compressed gas to the second location 208 for storage and/or transportation.

At block 406, the example valve 206 of FIGS. 2A and/or 2B is closed. For example, the operator closes the valve 206 to prevent and/or restrict flow of gas to the vent 106 via the flare line 102. In some examples, the valve 206 is automatically closed (e.g., by a motor and/or other actuator operatively coupled to the valve 206).

At block 408, a pressure of the gas in the flare line 102 is monitored by the operator. For example, the operator monitors the pressure measured and/or displayed by the example pressure sensor 210 of FIGS. 2A and/or 2B.

At block 410, the operator determines whether the pressure in the flare line 102 satisfies a second pressure threshold. For example, the operator determines that the pressure satisfies the second pressure threshold when the pressure is at or above the second pressure threshold. In response to a determination that the pressure satisfies the second pressure threshold (e.g., block 410 returns a result of YES), the process proceeds to block 412. Alternatively, in response to a determination that the pressure does not satisfy (e.g., is less than) the second pressure threshold (e.g., block 410 returns a result of NO), the process proceeds to block 414.

At block 412, the valve 206 is opened. For example, the operator opens the valve 206 to allow flow of gas to the vent 106 and, thus, reduce damage to the separator 104, the non-pressurized separator 222, and/or the fluid evacuation system 202 resulting from exposure to excess pressures. In some examples, the valve 206 can be opened automatically (e.g., by a motor and/or other actuator operatively coupled to the valve 206) when the pressure satisfies the second pressure threshold.

At block 414, the operator determines whether to continue the evacuation of gas from the flare line 102. For example, the operator determines to continue evacuation when gas is present in the flare line 102 (e.g., when the pressure of the gas in the flare line 102 is at or above a first pressure threshold less than the second pressure threshold). In response to a determination that evacuation is to continue (e.g., block 414 returns a result of YES), the process returns to block 408. Alternatively, in response to a determination that evacuation is complete (e.g., block 414 returns a result of NO), the process proceeds to block 416.

At block 416, the fluid evacuation system 202 and/or the auxiliary compressor(s) 224 is/are shut off. For example, the operator shuts off (e.g., deactivates) the fluid evacuation system 202 and/or the auxiliary compressor(s) 224 so that gas is no longer being evacuated from the flare line 102. In some examples, the fluid evacuation system 202 and/or the auxiliary compressor(s) 224 is/are removed (e.g., decoupled) from the flare line 102 upon completion of the flare gas capture procedure.

FIG. 5 is a flowchart representative of example machine readable instructions and/or example operations 500 that may be executed, instantiated, and/or performed by programmable circuitry to implement the example control system 212 of FIGS. 2A and/or 2B. The example machine-readable instructions and/or the example operations 500 of FIG. 5 begin at block 502, at which the example control system 212 determines whether gas is detected in the flare line 102 of FIGS. 1, 2A, and/or 2B. For example, the example pressure monitoring circuitry 218 of FIGS. 2A and/or 2B measures a pressure in the flare line 102, and detects gas in the flare line 102 when the pressure satisfies (e.g., is at or above) a first pressure threshold. In response to the pressure monitoring circuitry 218 detecting gas in the flare line 102 (e.g., block 502 returns a result of YES), control proceeds to block 504. Alternatively, in response to the pressure monitoring circuitry 218 not detecting gas in the flare line 102 (e.g., block 502 returns a result of NO), control returns to block 502 until gas is detected in the flare line 102.

At block 504, the example control system 212 turns on the example fluid evacuation system 202 and/or the auxiliary compressor(s) 224 of FIGS. 2A and/or 2B. For example, the example evacuation control circuitry 214 turns on the fluid evacuation system 202 and/or the auxiliary compressor(s) 224 so that the fluid evacuation system 202 and/or the auxiliary compressor(s) 224 can begin compressing and/or evacuating gas from the flare line 102.

At block 506, the example control system 212 causes the example valve 206 of FIGS. 2A and/or 2B to close. For example, the example valve control circuitry 216 of FIGS. 2A and/or 2B provides a control signal (e.g., an electrical signal and/or a pneumatic signal) to the valve 206 to cause the valve 206 to close, thus preventing and/or restricting flow of gas to the vent 106 via the flare line 102.

At block 508, the example control system 212 monitors the pressure of the gas in the flare line 102. For example, the valve control circuitry 216 monitors the pressure based on measurement data obtained by the example pressure sensor 210 of FIGS. 2A and/or 2B.

At block 510, the example control system 212 determines whether the pressure in the flare line 102 satisfies a second pressure threshold. For example, the pressure monitoring circuitry 218 determines that the pressure satisfies the second pressure threshold when the pressure is at or above the second pressure threshold. In response to the pressure monitoring circuitry 218 determining that the pressure satisfies the second pressure threshold (e.g., block 510 returns a result of YES), the process proceeds to block 512. Alternatively, in response to the pressure monitoring circuitry 218 determining that the pressure does not satisfy (e.g., is less than) the second pressure threshold (e.g., block 410 returns a result of NO), the process proceeds to block 516.

At block 512, the example control system 212 determines whether the valve 206 is open. In response to the valve control circuitry 216 determining that the valve 206 is open (e.g., block 512 returns a result of YES), control proceeds to block 520. Alternatively, in response to the valve control circuitry 216 determining that the valve 206 is closed (e.g., block 512 returns a result of NO), control proceeds to block 514.

At block 514, the example control system 212 causes the example valve 206 of FIGS. 2A and/or 2B to open. For example, the valve control circuitry 216 provides a control signal to the valve 206 to cause the valve 206 to open, thus allowing flow of gas to the vent 106 to reduce damage to the separator 104 and/or the fluid evacuation system 202 resulting from exposure to excess pressures.

At block 516, the example control system 212 determines whether the valve 206 is closed. In response to the valve control circuitry 216 determining that the valve 206 is closed (e.g., block 516 returns a result of YES), control proceeds to block 520. Alternatively, in response to the valve control circuitry 216 determining that the valve 206 is open (e.g., block 516 returns a result of NO), control proceeds to block 518.

At block 518, the example control system 212 causes the valve 206 to close. For example, the example valve control circuitry 216 of FIGS. 2A and/or 2B causes the valve 206 to close based on a control signal provided to the valve 206. In some examples, the valve 206 closes in response to the valve control circuitry 216 removing and/or halting the control signal to the valve 206.

At block 520, the example control system 212 determines whether to continue the evacuation of gas from the flare line 102. For example, the pressure monitoring circuitry 218 determines to continue evacuation when gas is detected in the flare line 102 (e.g., when the pressure of the gas in the flare line 102 is at or above the first pressure threshold). In response to the pressure monitoring circuitry 218 determining that evacuation is to continue (e.g., block 520 returns a result of YES), control returns to block 508. Alternatively, in response to the pressure monitoring circuitry 218 determining that evacuation is complete (e.g., block 520 returns a result of NO), control proceeds to block 522.

At block 522, the example control system 212 shuts off the fluid evacuation system 202 and/or the auxiliary compressor(s) 224. For example, the evacuation control circuitry 214 shuts off the fluid evacuation system 202 and/or the auxiliary compressor(s) 224 so that gas is no longer being evacuated from the flare line 102.

FIG. 6 is a block diagram of an example programmable circuitry platform 600 structured to execute and/or instantiate the example machine-readable instructions and/or the example operations of FIG. 5 to implement the control system 212 of FIGS. 2A and/or 2B. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example evacuation control circuitry 214, the example valve control circuitry 216, and the example pressure monitoring circuitry 218.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 5, may be stored in the mass storage device 628, in the volatile memory 614, in the non-volatile memory 616, and/or on at least one non-transitory computer readable storage medium such as a CD or DVD which may be removable.

From the foregoing, it will be appreciated that example systems, apparatus, articles of manufacture, and methods have been disclosed that enable reduction of methane emissions by evacuating and/or capturing natural gas from a gas flare line. The disclosed systems, apparatus, articles of manufacture, and methods implement a fluid evacuation system on the gas flare line to evacuate and/or compress gas therefrom and, thus, reduce an amount of the gas to be flared and/or vented to the atmosphere. Further, an example valve is implemented on the gas flare line downstream of the fluid evacuation system and upstream of a vent of the gas flare line. The valve moves to a closed position when a pressure of the gas is below a threshold, thus restricting and/or preventing flow of gas to the vent. Conversely, the valve moves to an open position when the pressure of the gas is at or above the threshold, thus relieving pressure in the gas flare line and reducing risk of damage to one or more components operatively coupled thereto. Advantageously, the disclosed systems, methods, apparatus, and articles of manufacture reduce emission of methane into the atmosphere, thus reducing environmental harm, economic waste, and/or risk of accidental combustion compared to venting and/or flaring of gas.

Example flare gas capture apparatus, control, and associated methods are disclosed herein. Further examples and combinations thereof include the following:
Example 1 includes an apparatus comprising a fluid evacuation system operatively coupled to a gas flare line to evacuate gas from the gas flare line, and a valve operatively coupled to the gas flare line downstream of the fluid evacuation system and upstream of a vent of the gas flare line, the valve movable between a first position and a second position based on a pressure of the gas, the valve to restrict flow of the gas to the vent in the first position, the valve to enable the flow of the gas to the vent in the second position.
Example 2 includes the apparatus of example 1, wherein the fluid evacuation system is to compress the evacuated gas and pump the compressed evacuated gas to a second location.
Example 3 includes the apparatus of example 2, wherein the second location corresponds to a gas pipeline separate from the gas flare line.
Example 4 includes the apparatus of example 2, wherein the second location corresponds to a gas storage unit.
Example 5 includes the apparatus of example 2, wherein the second location corresponds to a downhole location of a well.
Example 6 includes the apparatus of example 1, wherein the fluid evacuation system is fluidly coupled to a tee implemented on the gas flare line, further including a pressure sensor operatively coupled to the gas flare line upstream of the tee.
Example 7 includes the apparatus of example 6, wherein the pressure sensor is to measure the pressure of the gas in the gas flare line, and at least one of display the measured pressure or communicate the measured pressure to a control system operatively coupled to the fluid evacuation system.
Example 8 includes the apparatus of example 1, wherein the gas flare line is fluidly coupled to a separator, the gas to flow via the gas flare line from the separator toward the vent.
Example 9 includes the apparatus of example 1, further including at least one auxiliary compressor fluidly coupled between the gas flare line and the fluid evacuation system, the at least one auxiliary compressor to compress the gas to a first pressure, the fluid evacuation system to compress the gas to a second pressure greater than the first pressure.
Example 10 includes a method comprising activating a fluid evacuation system operatively coupled to a gas flare line to evacuate gas from the gas flare line, when a pressure of the gas in the gas flare line satisfies a threshold pressure, opening a valve operatively coupled to the gas flare line downstream of the fluid evacuation system and upstream of a vent of the gas flare line, the valve to enable flow of gas to the vent in an open position, and closing the valve when the pressure of the gas in the gas flare line does not satisfy the threshold pressure, the valve in a closed position to restrict the flow of the gas to the vent.
Example 11 includes the method of example 10, further including compressing, via the fluid evacuation system, the evacuated gas and pumping the compressed evacuated gas to a second location.
Example 12 includes the method of example 11, wherein the second location corresponds to a gas pipeline separate from the gas flare line.
Example 13 includes the method of example 11, wherein the second location corresponds to a gas storage unit.
Example 14 includes the method of example 10, further including fluidly coupling the fluid evacuation system to a tee implemented on the gas flare line, and operatively coupling a pressure sensor to the gas flare line upstream of the tee.
Example 15 includes the method of example 14, further including measuring, via the pressure sensor, the pressure of the gas in the gas flare line, and at least one of displaying, via the pressure sensor, the measured pressure or communicating the measured pressure to a control system operatively coupled to the fluid evacuation system.
Example 16 includes the method of example 10, further including fluidly coupling the gas flare line to a separator, the gas to flow via the gas flare line from the separator toward the vent.
Example 17 includes a system comprising evacuation control circuitry operatively coupled to a fluid evacuation system, the fluid evacuation system operatively coupled to a gas flare line, the evacuation control circuitry to activate the fluid evacuation system to evacuate gas from the gas flare line, pressure monitoring circuitry to determine a pressure of the gas in the gas flare line based on data from a sensor operatively coupled to the gas flare line, and valve control circuitry operatively coupled to a valve, the valve operatively coupled to the gas flare line downstream of the fluid evacuation system and upstream of a vent of the gas flare line, the valve control circuitry to move the valve to a first position when the pressure of the gas satisfies a threshold pressure, the valve to enable flow of the gas to the vent in the first position, and move the valve to a second position when the pressure of the gas does not satisfy the threshold pressure, the valve to restrict the flow of the gas to the vent in the second position.
Example 18 includes the system of example 17, wherein the evacuation control circuitry is to cause the fluid evacuation system to compress the evacuated gas and pump the compressed evacuated gas to a second location.
Example 19 includes the system of example 17, wherein the threshold pressure is a first threshold pressure, the evacuation control circuitry to activate the fluid evacuation system when the pressure of the gas satisfies a second threshold pressure, the evacuation control circuitry to deactivate the fluid evacuation system when the pressure of the gas does not satisfy the second threshold pressure, the first threshold pressure greater than the second threshold pressure.
Example 20 includes the system of example 17, wherein the evacuation control circuitry is to, when the fluid evacuation system is activated, activate at least one auxiliary compressor fluidly coupled between the fluid evacuation system and the gas flare line.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a fluid evacuation system operatively coupled to a gas flare line to evacuate gas from the gas flare line; and
a valve operatively coupled to the gas flare line downstream of the fluid evacuation system and upstream of a vent of the gas flare line, the valve movable between a first position and a second position based on a pressure of the gas, the valve to restrict flow of the gas to the vent in the first position, the valve to enable the flow of the gas to the vent in the second position.

2. The apparatus of claim 1, wherein the fluid evacuation system is to compress the evacuated gas and pump the compressed evacuated gas to a second location.

3. The apparatus of claim 2, wherein the second location corresponds to a gas pipeline separate from the gas flare line.

4. The apparatus of claim 2, wherein the second location corresponds to a gas storage unit.

5. The apparatus of claim 2, wherein the second location corresponds to a downhole location of a well.

6. The apparatus of claim 1, wherein the fluid evacuation system is fluidly coupled to a tee implemented on the gas flare line, further including a pressure sensor operatively coupled to the gas flare line upstream of the tee.

7. The apparatus of claim 6, wherein the pressure sensor is to:
measure the pressure of the gas in the gas flare line; and
at least one of display the measured pressure or communicate the measured pressure to a control system operatively coupled to the fluid evacuation system.

8. The apparatus of claim 1, wherein the gas flare line is fluidly coupled to a separator, the gas to flow via the gas flare line from the separator toward the vent.

9. The apparatus of claim 1, further including at least one auxiliary compressor fluidly coupled between the gas flare line and the fluid evacuation system, the at least one auxiliary compressor to compress the gas to a first pressure, the fluid evacuation system to compress the gas to a second pressure greater than the first pressure.

10. A method comprising:
activating a fluid evacuation system operatively coupled to a gas flare line to evacuate gas from the gas flare line;
when a pressure of the gas in the gas flare line satisfies a threshold pressure, opening a valve operatively coupled to the gas flare line downstream of the fluid evacuation system and upstream of a vent of the gas flare line, the valve to enable flow of gas to the vent in an open position; and
closing the valve when the pressure of the gas in the gas flare line does not satisfy the threshold pressure, the valve in a closed position to restrict the flow of the gas to the vent.

11. The method of claim 10, further including compressing, via the fluid evacuation system, the evacuated gas and pumping the compressed evacuated gas to a second location.

12. The method of claim 11, wherein the second location corresponds to a gas pipeline separate from the gas flare line.

13. The method of claim 11, wherein the second location corresponds to a gas storage unit.

14. The method of claim 10, further including:
fluidly coupling the fluid evacuation system to a tee implemented on the gas flare line; and
operatively coupling a pressure sensor to the gas flare line upstream of the tee.

15. The method of claim 14, further including:
measuring, via the pressure sensor, the pressure of the gas in the gas flare line; and
at least one of displaying, via the pressure sensor, the measured pressure or communicating the measured pressure to a control system operatively coupled to the fluid evacuation system.

16. The method of claim 10, further including fluidly coupling the gas flare line to a separator, the gas to flow via the gas flare line from the separator toward the vent.

17. A system comprising:
evacuation control circuitry operatively coupled to a fluid evacuation system, the fluid evacuation system operatively coupled to a gas flare line, the evacuation control circuitry to activate the fluid evacuation system to evacuate gas from the gas flare line;
pressure monitoring circuitry to determine a pressure of the gas in the gas flare line based on data from a sensor operatively coupled to the gas flare line; and
valve control circuitry operatively coupled to a valve, the valve operatively coupled to the gas flare line downstream of the fluid evacuation system and upstream of a vent of the gas flare line, the valve control circuitry to:
move the valve to a first position when the pressure of the gas satisfies a threshold pressure, the valve to enable flow of the gas to the vent in the first position; and
move the valve to a second position when the pressure of the gas does not satisfy the threshold pressure, the valve to restrict the flow of the gas to the vent in the second position.

18. The system of claim 17, wherein the evacuation control circuitry is to cause the fluid evacuation system to compress the evacuated gas and pump the compressed evacuated gas to a second location.

19. The system of claim 17, wherein the threshold pressure is a first threshold pressure, the evacuation control circuitry to activate the fluid evacuation system when the pressure of the gas satisfies a second threshold pressure, the evacuation control circuitry to deactivate the fluid evacuation system when the pressure of the gas does not satisfy the second threshold pressure, the first threshold pressure greater than the second threshold pressure.

20. The system of claim 17, wherein the evacuation control circuitry is to, when the fluid evacuation system is activated, activate at least one auxiliary compressor fluidly coupled between the fluid evacuation system and the gas flare line.
